(19) United States
(12) Patent Application Publication
(10) Pub. No.: US 2026/0088874 A1
(43) Pub. Date: Mar. 26, 2026

(54) DETERMINING A BEAM FOR COMMUNICATION USING LEARNING TECHNIQUES

(71) Applicant: Lenovo (Singapore) Pte. Ltd., Singapore (SG)

(72) Inventors: Venkata Srinivas Kothapalli, Chicago, IL (US); Ahmed Hindy, Aurora, IL (US); Vahid Pourahmadi, München (DE); Vijay Nangia, Woodridge, IL (US)

(21) Appl. No.: 19/112,567

(22) PCT Filed: Sep. 28, 2023
(86) PCT No.: PCT/IB2023/059719

§ 371 Date: Mar. 17, 2025

Related U.S. Application Data
(60) Provisional application No. 63/410,915, filed on Sep. 28, 2022.

(51) Int. Cl. H04B 7/06; H04L 41/16

(52) U.S. Cl. CPC H04B 7/0626; H04B 7/06952; H04L 41/16

(57) ABSTRACT

OF THE DISCLOSURE Apparatuses, methods, and systems are disclosed for determining a beam for communication using learning techniques. One method (500) includes receiving (502), at a user equipment (“UE”), a set of reference signals from a network node. The set of reference signals correspond to a set of beams. The method (500) includes identifying (504) a preferred beam based on a learning module and a neural network (“NN”) model. The method (500) includes determining (506), by the learning module, a first candidate beam based on a set of beam measurements corresponding to a subset of the set of reference signals. The set of beam measurements include reference signal received power (“RSRP”) measurements or signal-to-interference and noise ratio (“SINR”) measurements. The method (500) includes determining (508) whether the first candidate beam satisfies a metric. The method (500) includes determining (510) the preferred beam as the first candidate beam.

### FIELD

The subject matter disclosed herein relates generally to wireless communications and more particularly relates to determining a beam for communication using learning techniques.

### BACKGROUND

In certain wireless communications systems, different beams have different qualities. A certain beam may be selected for certain communications.

### BRIEF SUMMARY

Methods for determining a beam for communication using learning techniques are disclosed. Apparatuses and systems also perform the functions of the methods. One embodiment of a method includes receiving, at a user equipment (“UE”), a set of reference signals from a network node. The set of reference signals correspond to a set of beams. In some embodiments, the method includes identifying a preferred beam based on a learning module and a neural network (“NN”) model. In certain embodiments, the method includes determining, by the learning module, a first candidate beam based on a set of beam measurements corresponding to a subset of the set of reference signals. The set of beam measurements include reference signal received power (“RSRP”) measurements or signal-to-interference and noise ratio (“SINR”) measurements. In various embodiments, the method includes determining whether the first candidate beam satisfies a metric. In some embodiments, the method includes determining the preferred beam as the first candidate beam in response to determining the first candidate beam satisfying the metric. In certain embodiments, the method includes determining a second candidate beam as the preferred beam based on the NN model and the set of beam measurements in response to determining the first candidate beam does not satisfy the metric. In various embodiments, the method includes reporting an index of the preferred beam in a channel state information (“CSI”) report to the network node.

One apparatus for determining a beam for communication using learning techniques includes a processor. In some embodiments, the apparatus includes a memory coupled to the processor, the processor configured to cause the apparatus to: receive a set of reference signals from a network node, wherein the set of reference signals correspond to a set of beams; identify a preferred beam based on a learning module and a NN model; determine, by the learning module, a first candidate beam based on a set of beam measurements corresponding to a subset of the set of reference signals, wherein the set of beam measurements include RSRP measurements or SINR measurements; determine whether the first candidate beam satisfies a metric; determine the preferred beam as the first candidate beam in response to determining the first candidate beam satisfying the metric; determine a second candidate beam as the preferred beam based on the NN model and the set of beam measurements in response to determining the first candidate beam does not satisfy the metric; and report an index of the preferred beam in a CSI report to the network node.

Another embodiment of a method for determining a beam for communication using learning techniques includes transmitting, at a network node, a set of reference signals to a UE, wherein the set of reference signals correspond to a set of beams. In some embodiments, the method includes receiving an index of a preferred beam in a CSI report from the UE. The preferred beam is identified based on a learning module and a NN model, a first candidate beam is determined based on a set of beam measurements corresponding to a subset of the set of reference signals, the set of beam measurements comprise RSRP measurements or SINR measurements, the preferred beam is determined as the first candidate beam in response to the first candidate beam satisfying a metric, and a second candidate beam is determined as the preferred beam based on the NN model and the set of beam measurements in response to the first candidate beam not satisfying the metric.

Another apparatus for determining a beam for communication using learning techniques includes a processor. In some embodiments, the apparatus includes a memory coupled to the processor, the processor configured to cause the apparatus to: transmit a set of reference signals to a UE, wherein the set of reference signals correspond to a set of beams; and receive an index of a preferred beam in a CSI report from the UE. The preferred beam is identified based on a learning module and a NN model, a first candidate beam is determined based on a set of beam measurements corresponding to a subset of the set of reference signals, the set of beam measurements comprise RSRP measurements or SINR measurements, the preferred beam is determined as the first candidate beam in response to the first candidate beam satisfying a metric, and a second candidate beam is determined as the preferred beam based on the NN model and the set of beam measurements in response to the first candidate beam not satisfying the metric.

A further embodiment of a method for determining a beam for communication using learning techniques includes receiving, at a network node, a set of reference signals from a UE. The set of reference signals correspond to a set of beams. In some embodiments, the method includes identifying a preferred beam based on a learning module and a NN model. In certain embodiments, the method includes determining, by the learning module, a first candidate beam based on a set of beam measurements corresponding to a subset of the set of reference signals. The set of beam measurements include RSRP measurements or SINR measurements. In various embodiments, the method includes determining whether the first candidate beam satisfies a metric. In some embodiments, the method includes determining the preferred beam as the first candidate beam in response to determining the first candidate beam satisfying the metric. In certain embodiments, the method includes determining a second candidate beam as the preferred beam based on the NN model and the set of beam measurements in response to determining the first candidate beam does not satisfy the metric. In various embodiments, the method includes reporting an index of the preferred beam to the UE.

A further apparatus for determining a beam for communication using learning techniques includes a processor. In some embodiments, the apparatus includes a memory coupled to the processor, the processor configured to cause the apparatus to: receive a set of reference signals from a UE, wherein the set of reference signals correspond to a set of beams; identify a preferred beam based on a learning module and a NN model; determine, by the learning module, a first candidate beam based on a set of beam measurements corresponding to a subset of the set of reference signals, wherein the set of beam measurements comprise RSRP measurements or SINR measurements; determine whether the first candidate beam satisfies a metric; determine the preferred beam as the first candidate beam in response to determining the first candidate beam satisfying the metric; determine a second candidate beam as the preferred beam based on the NN model and the set of beam measurements in response to determining the first candidate beam does not satisfy the metric; and report an index of the preferred beam to the UE.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for determining a beam for communication using learning techniques;

FIG. 2 is a schematic block diagram illustrating one embodiment of an apparatus that may be used for determining a beam for communication using learning techniques;

FIG. 3 is a schematic block diagram illustrating one embodiment of an apparatus that may be used for determining a beam for communication using learning techniques;

FIG. 4 is a flow chart diagram illustrating one embodiment of a method for determining a beam for communication using learning techniques;

FIG. 5 is a flow chart diagram illustrating another embodiment of a method for determining a beam for communication using learning techniques; and

FIG. 6 is a flow chart diagram illustrating a further embodiment of a method for determining a beam for communication using learning techniques.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block ofthe schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

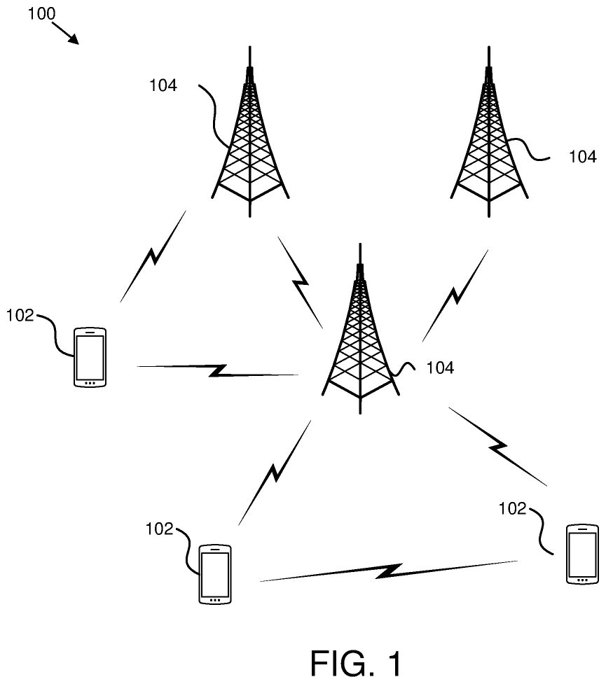

FIG. 1 depicts an embodiment of a wireless communication system 100 for determining a beam for communication using learning techniques. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an orthogonal frequency division multiplexing (“OFDM”) modulation scheme on the downlink (“DL”) and the remote units 102 transmit on the uplink (“UL”) using a single-carrier frequency division multiple access (“SC-FDMA”) scheme or an OFDM scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may receive a set of reference signals from a network node. The set of reference signals correspond to a set of beams. In some embodiments, the remote unit 102 may identify a preferred beam based on a learning module and a NN model. In certain embodiments, the remote unit 102 may determine, by the learning module, a first candidate beam based on a set of beam measurements corresponding to a subset of the set of reference signals. The set of beam measurements include RSRP measurements or SINR measurements. In various embodiments, the remote unit 102 may determine whether the first candidate beam satisfies a metric. In some embodiments, the remote unit 102 may determine the preferred beam as the first candidate beam in response to determining the first candidate beam satisfying the metric. In certain embodiments, the remote unit 102 may determine a second candidate beam as the preferred beam based on the NN model and the set of beam measurements in response to determining the first candidate beam does not satisfy the metric. In various embodiments, the remote unit 102 may report an index of the preferred beam in a CSI report to the network node. Accordingly, the remote unit 102 may be used for determining a beam for communication using learning techniques.

In certain embodiments, a network unit 104 may transmit a set of reference signals to a UE, wherein the set of reference signals correspond to a set of beams. In some embodiments, the network unit 104 may receive an index of a preferred beam in a CSI report from the UE, wherein the preferred beam is identified based on a learning module and a NN model, a first candidate beam is determined based on a set of beam measurements corresponding to a subset of the set of reference signals, the set of beam measurements comprise RSRP measurements or SINR measurements, the preferred beam is determined as the first candidate beam in response to the first candidate beam satisfying a metric, and a second candidate beam is determined as the preferred beam based on the NN model and the set of beam measurements in response to the first candidate beam not satisfying the metric. Accordingly, the network unit 104 may be used for determining a beam for communication using learning techniques.

In some embodiments, a network unit 104 may receive a set of reference signals from a UE. The set of reference signals correspond to a set of beams. In some embodiments, the network unit 104 may identify a preferred beam based on a learning module and a NN model. In certain embodiments, the network unit 104 may determine, by the learning module, a first candidate beam based on a set of beam measurements corresponding to a subset of the set of reference signals. The set of beam measurements include RSRP measurements or SINR measurements. In various embodiments, the network unit 104 may determine whether the first candidate beam satisfies a metric. In some embodiments, the network unit 104 may determine the preferred beam as the first candidate beam in response to determining the first candidate beam satisfying the metric. In certain embodiments, the network unit 104 may determine a second candidate beam as the preferred beam based on the NN model and the set of beam measurements in response to determining the first candidate beam does not satisfy the metric. In various embodiments, the network unit 104 may report an index of the preferred beam to the UE. Accordingly, the network unit 104 may be used for determining a beam for communication using learning techniques.

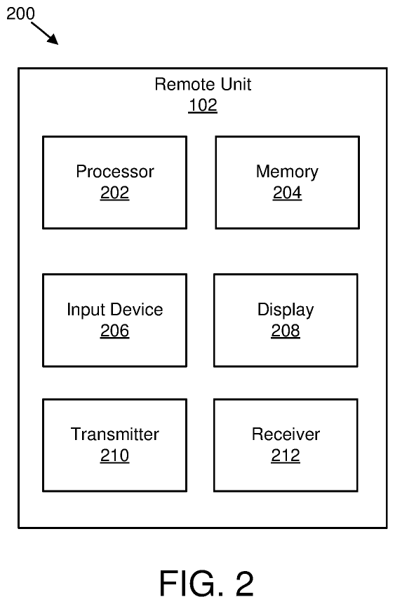

FIG. 2 depicts one embodiment of an apparatus 200 that may be used for determining a beam for communication using learning techniques. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the processor 202 is configured to cause the apparatus to: receive a set of reference signals from a network node, wherein the set of reference signals correspond to a set of beams; identify a preferred beam based on a learning module and a NN model; determine, by the learning module, a first candidate beam based on a set of beam measurements corresponding to a subset of the set of reference signals, wherein the set of beam measurements include RSRP measurements or SINR measurements; determine whether the first candidate beam satisfies a metric; determine the preferred beam as the first candidate beam in response to determining the first candidate beam satisfying the metric; determine a second candidate beam as the preferred beam based on the NN model and the set of beam measurements in response to determining the first candidate beam does not satisfy the metric; and report an index of the preferred beam in a CSI report to the network node.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

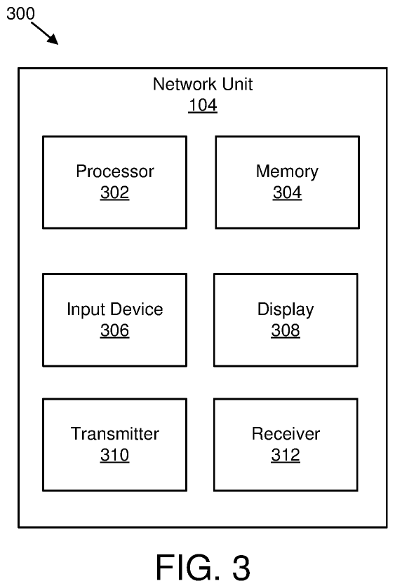

FIG. 3 depicts one embodiment of an apparatus 300 that may be used for determining a beam for communication using learning techniques. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the processor 302 is configured to cause the apparatus to: transmit a set of reference signals to a UE, wherein the set of reference signals correspond to a set of beams; and receive an index of a preferred beam in a CSI report from the UE. The preferred beam is identified based on a learning module and a NN model, a first candidate beam is determined based on a set of beam measurements corresponding to a subset of the set of reference signals, the set of beam measurements comprise RSRP measurements or SINR measurements, the preferred beam is determined as the first candidate beam in response to the first candidate beam satisfying a metric, and a second candidate beam is determined as the preferred beam based on the NN model and the set of beam measurements in response to the first candidate beam not satisfying the metric.

In some embodiments, the processor 302 is configured to cause the apparatus to: receive a set of reference signals from a UE, wherein the set of reference signals correspond to a set of beams; identify a preferred beam based on a learning module and a NN model; determine, by the learning module, a first candidate beam based on a set of beam measurements corresponding to a subset of the set of reference signals, wherein the set of beam measurements comprise RSRP measurements or SINR measurements; determine whether the first candidate beam satisfies a metric; determine the preferred beam as the first candidate beam in response to determining the first candidate beam satisfying the metric; determine a second candidate beam as the preferred beam based on the NN model and the set of beam measurements in response to determining the first candidate beam does not satisfy the metric; and report an index of the preferred beam to the UE.

It should be noted that one or more embodiments described herein may be combined into a single embodiment.

In certain embodiments, a wireless cellular network includes a base station denoted as gNB. In such embodiments, the gNB is equipped with M multiple antennas (e.g., in the form of one or more antenna array panels) and K UEs each having one or more antenna array panels with multiple antenna elements in each panel. The network operates in millimeter wave (“mmWave”) frequencies (e.g., frequency range 2 (“FR2”)) in a fifth generation (“5G”) new radio (“NR”) system. In the mmWave frequency range, it may be common to communicate through narrow beams formed using multiple antenna elements available at the gNB and the UEs (e.g., to overcome a high amount of propagation losses at such frequencies and to maintain sufficient signal strength). The total number beams formed by the gNB (e.g., across all its antenna panels) may be represented by M and each UE forms N number of beams. Such beams are directional in nature (e.g., providing directional gain) and, typically have a narrow beam width. For achieving a reliable communication link between the gNB and the UE, an appropriate beam may be selected at the gNB and a corresponding beam at the UE. In other words, for enabling communication between a gNB and a UE, a beam-pair is selected (e.g., a beam at the gNB and a beam at the UE) that results in a high signal strength at the receiver. This procedure may be known as beam search, or beam selection. In the downlink, beam selection corresponds to selecting a transmit (“TX”) beam at the gNB and a corresponding receive (“RX”) beam at the UE. Similarly, for uplink, a TX beam is selected at the UE and there is a corresponding RX beam at a gNB. It should be noted that a beam corresponds to an non-zero power (“NZP”) channel state information (“CSI”) reference signal (“RS”) (“CSI-RS”) resource of at least one NZP CSI-RS resource set, wherein the NZP CSI-RS resource set is configured with a higher-layer parameter ‘repetition’.

In some embodiments, beam selection is an important and challenging problem, requiring novel and efficient solutions to enable the successful functioning of 5G NR cellular networks at mmWave frequencies. A straightforward way to select the beams is to search over all possible beams and select the beam that offers maximum signal strength. This method, which may be called an exhaustive search, may be explained as follows for downlink communication. For selecting a TX beam at the gNB for a given RX beam at the UE, the gNB sends a reference signal on all possible TX beams, the UE measures the received signal strength (e.g., equivalently, layer 1 (“L1”) reference signal received power (“RSRP”) and/or L1 signal-to-interference and noise ratio (“SINR”)) on all those beams and finds the beam providing a highest RSRP and/or SINR and reports back the best beam index to the gNB. In a similar manner, the RX beam at the UE is selected by fixing the TX beam at the gNB and sweeping the RX beams at the UE, then measuring the received signal strength from each RX beam. Such exhaustive search may result in selecting the optimal beam (e.g., optimal in terms of the signal strength), but at the cost of huge latency and overhead.

In various embodiments, there may be beam selection methods that use minimal resources (e.g., such as transmission bandwidth, measured in terms of the number of time-frequency bins, transmission power, computational complexity, and so forth) and a best beam with low latency may be determined. It should be noted that a beam selection method may be efficient if a number of beam measurements it requires for determining the best beam is low and it does not demand computationally complex calculations. The problem of beam selection may become further complicated by the possibility that there could be errors in measuring and reporting the signal strength over the beams during the beam selection procedure.

In certain embodiments, beam selection may be performed based on concepts from machine learning.

In some embodiments, there may be CSI-RS provided for L1-RSRP and L1-SINR computation. If a UE is configured with a NZP-CSI-RS-ResourceSet configured with the higher layer parameter repetition set to ‘on’, the UE may assume that the CSI-RS resources within the NZP-CSI-RS-ResourceSet are transmitted with the same downlink spatial domain transmission filter, where the CSI-RS resources in the NZP-CSI-RS-ResourceSet are transmitted in different orthogonal frequency division multiplexing (“OFDM”) symbols. If repetition is set to ‘off’, the UE may not assume that the CSI-RS resources within the NZP-CSI-RS-ResourceSet are transmitted with the same downlink spatial domain transmission filter.

If the UE is configured with a CSI-ReportConfig with reportQuantity set to ‘cri-RSRP’, ‘cri-SINR’ or ‘none’ and if the CSI-ResourceConfig for channel measurement (e.g., higher layer parameter resourcesForChannelMeasurement) contains a NZP-CSI-RS-ResourceSet that is configured with the higher layer parameter repetition and without the higher layer parameter trs-Info, the UE can only be configured with the same number (e.g., 1 or 2) of ports with the higher layer parameter nrofPorts for all CSI-RS resources within the set. If the UE is configured with the CSI-RS resource in the same OFDM symbols as a synchronization signal (“SS”) and/or physical broadcast channel (“PBCH”) (“SS/PBCH”) block, the UE may assume that the CSI-RS and the SS/PBCH block are quasi co-located with ‘typeD’ if ‘typeD’ is applicable. Furthermore, the UE may not expect to be configured with the CSI-RS in physical resource blocks (“PRBs”) that overlap with those of the SS/PBCH block, and the UE may expect that the same subcarrier spacing is used for both the CSI-RS and the SS/PBCH block.

In various embodiments, there may be L1-RSRP reporting. In such embodiments, for L1-RSRP computation: 1) the UE may be configured with CSI-RS resources, SS/PBCH block resources or both CSI-RS and SS/PBCH block resources, when resource-wise quasi co-located with ‘type C’ and ‘typeD’; and 2) the UE may be configured with CSI-RS resource setting up to 16 CSI-RS resource sets having up to 64 resources within each set. The total number of different CSI-RS resources over all resource sets is no more than 128.

For L1-RSRP reporting, if the higher layer parameter nrofReportedRS in CSI-ReportConfig is configured to be one, the reported L1-RSRP value is defined by a 7-bit value in the range [−140, −44] dBm with 1 dB step size, if the higher layer parameter nrofReportedRS is configured to be larger than one, or if the higher layer parameter groupBasedBeamReporting is configured as ‘enabled’, or if the higher layer parameter groupBasedBeamReporting-r17 is configured, the UE shall use differential L1-RSRP based reporting, where the largest measured value of L1-RSRP is quantized to a 7-bit value in the range [−140, −44] dBm with 1 dB step size, and the differential L1-RSRP is quantized to a 4-bit value. The differential L1-RSRP value is computed with 2 dB step size with a reference to the largest measured L1-RSRP value which is part of the same L1-RSRP reporting instance. The mapping between the reported L1-RSRP value and the measured quantity is described in.

In some embodiments, when the higher layer parameter groupBasedBeamReporting-r17in CSI-ReportConfig is configured, the UE may indicate the CSI resource set associated with the largest measured value of L1-RSRP, and for each group, CRI or SSBRI of the indicated CSI resource set is present first.

If the higher layer parameter timeRestrictionForChannelMeasurements in CSI-ReportConfig is set to “notConfigured”, the UE may derive the channel measurements for computing L1-RSRP value reported in uplink slot n based on only the SS/PBCH or NZP CSI-RS, no later than the CSI reference resource associated with the CSI resource setting.

If the higher layer parameter timeRestrictionForChannelMeasurements in CSI-ReportConfig is set to “Configured”, the UE may derive the channel measurements for computing L1-RSRP reported in uplink slot n based on only the most recent, no later than the CSI reference resource, occasion of SS/PBCH or NZP CSI-RS associated with the CSI resource setting.

In various embodiments, when the UE is configured with [NumberOfAdditionalPCI], a CSI-SSB-ResourceSet configured for L1-RSRP reporting includes one or more sets of SSB indices where PCI indices are associated with the sets of SSB indices, respectively.

In certain embodiments, when the UE is configured with a CSI-ReportConfig with the higher layer parameter reportQuantity set to ‘cri-RSRP-Capability[Set]Index’ or ‘ssb-Index-RSRP-Capability[Set]Index’ an index of UE capability value set, indicating the maximum supported number of sounding reference signal (“SRS”) antenna ports, is reported along with the pair of SSBRI/CRI and L1-RSRP.

In some embodiments, there may be L1-SINR reporting. For L1-SINR computation, for channel measurement the UE may be configured with NZP CSI-RS resources and/or SS/PBCH Block resources, and for interference measurement the UE may be configured with NZP CSI-RS or CSI-IM resources. For channel measurement, the UE may be configured with CSI-RS resource setting with up to 16 resource sets, with a total of up to 64 CSI-RS resources or up to 64 SS/PBCH Block resources.

For L1-SINR reporting, if the higher layer parameter nrofReportedRS in CSI-ReportConfig is configured to be one, the reported L1-SINR value is defined by a 7-bit value in the range [−23, 40] dB with 0.5 dB step size, and if the higher layer parameter nrofReportedRS is configured to be larger than one, or if the higher layer parameter groupBasedBeamReporting is configured as ‘enabled’, the UE may use differential L1-SINR based reporting, where the largest measured value of L1-SINR is quantized to a 7-bit value in the range [−23, 40] dB with 0.5 dB step size, and the differential L1-SINR is quantized to a 4-bit value. The differential L1-SINR is computed with 1 dB step size with a reference to the largest measured L1-SINR value which is part of the same L1-SINR reporting instance. When NZP CSI-RS is configured for channel measurement and/or interference measurement, the reported L1-SINR values should not be compensated by the power offset(s) given by higher layer parameter powerControOffsetSS or powerControlOffset.

In various embodiments, when one or two resource settings are configured for L1-SINR measurement:
1) if the higher layer parameter timeRestrictionForChannelMeasurements in CSI-ReportConfig is set to ‘notConfigured’, the UE may derive the channel measurements for computing L1-SINR reported in uplink slot n based on only the SSB or NZP CSI-RS, no later than the CSI reference resource associated with the CSI resource setting;
2) if the higher layer parameter timeRestrictionForChannelMeasurements in CSI-ReportConfig is set to ‘configured’, the UE may derive the channel measurements for computing L1-SINR reported in uplink slot n based on only the most recent, no later than the CSI reference resource, occasion of SSB or NZP CSI-RS associated with the CSI resource setting;
3) if the higher layer parameter timeRestrictionForInterferenceMeasurements in CSI-ReportConfig is set to ‘notConfigured’, the UE may derive the interference measurements for computing L1-SINR reported in uplink slot n based on only the CSI-IM or NZP CSI-RS for interference measurement or NZP CSI-RS for channel and interference measurement no later than the CSI reference resource associated with the CSI resource setting; and
4) if the higher layer parameter timeRestrictionForInterferenceMeasurements in CSI-ReportConfig is set to ‘configured’, the UE may derive the interference measurements for computing the L1-SINR reported in uplink slot n based on the most recent, no later than the CSI reference resource, occasion of CSI-IM or NZP CSI-RS for interference measurement or NZP CSI-RS for channel and interference measurement associated with the CSI resource setting.

In certain embodiments, when the UE is configured with a CSI-ReportConfig with the higher layer parameter reportQuantity set to ‘cri-SINR-Capability[Set]Index’ or ‘ssb-Index-SINR-Capability[Set]Index’, an index of UE capability value indicating the maximum supported number of SRS antenna ports is reported along with the pair of SSBRI/CRI and L1-SINR.

In some embodiments, there may be uplink control information (“UCI”) corresponding to beam-based CSI reporting.

In various embodiments, a bitwidth for CSI-RS resource indicator (“CRI”), SS/PBCH resource block indicator (“SSBRI”), RSRP, differential RSRP, and CapabilityIndex are provided in Table 1.

TABLE 1
CRI, SSBRI, RSRP, and CapabilityIndex

| Field | Bitwidth |
|---|---|
| CRI | ┌log₂(Kₛ^{CSI-RS})┐ |
| SSBRI | ┌log₂(Kₛ^{SSB})┐ |
| RSRP | 7 |
| Differential | 4 |
| RSRP | |
| CapabilityIndex | x |

In such embodiments,

$${K}_{s}^{CSI - RS}$$

is the number of CSI-RS resources in the corresponding resource set, and

$${K}_{s}^{SSB}$$

is the configured number of SS/PBCH blocks in the corresponding resource set for reporting ‘ssb-Index-RSRP’.

In certain embodiments, a bitwidth for CRI, SSBRI, SINR, differential SINR, and CapabilityIndex are provided in Table 2.

TABLE 2
CRI, SSBRI, SINR, and CapabilityIndex

| Field | Bitwidth |
|---|---|
| CRI | $⌈ {log}_{2} ( {K}_{s}^{CSI - RS} ) ⌉$ |
| SSBRI | $⌈ {log}_{2} ( {K}_{s}^{SSB} ) ⌉$ |
| SINR | 7 |
| Differential | 4 |
| SINR | |
| CapabilityIndex | x |

In such embodiments,

$${K}_{s}^{CSI - RS}$$

is the number of CSI-RS resources in the corresponding resource set, and

$${K}_{s}^{SSB}$$

is the configured number of SS/PBCH blocks in the corresponding resource set for reporting ‘ssb-Index-SINR’.

In some embodiments, a common way of beam selection is through measuring the signal strength over all possible beams. As the overhead (e.g., overhead due to the transmitting reference signals on each possible beam and transmitting the measurement reports), complexity and latency (e.g., in performing the beam measurements) of this method becomes prohibitive with increasing number of beams at the gNB and the UE. Various embodiments are based on estimating an angle of arrival (“AoA”) and angle of departure (“AoD”) at the TX and RX exploiting the sparse nature of the mmWave propagation. However, the mmWave propagation mechanism, and hence the sparse nature of it, is heavily dependent on the underlying physical medium and the associated details (e.g., such as the number of location of reflectors, absorption coefficient of obstacles, etc.) which varies dynamically with multiple parameters (e.g., such as the time of the day, weather, etc.) such methods may not always result in optimal beam selection.

In various embodiments, there may be machine learning for beam selection via supervised learning. The rapidly emerging field of machine learning and/or deep learning has motivated wireless community to develop efficient solutions to the problem of beam selection. Many of such methods are based on supervised learning (“SupL”) which trains a neural network based on training data, obtained either through simulations or through field trials, considering either one or, at most, a finite set of physical cell-sites or a finite set of network configurations. One supervised learning method for beam selection is described as follows: Consider the case of selecting one beam out of M beams (e.g., value of M, typically, ranges from 8 to 256). The beams, typically, will span over an angular space with each beam directed towards a different azimuth and/or elevation angle and the footprint of the beams might span a two-dimensional space. Exhaustive beam selection requires M beam measurements. A SupL method trains a neural network (“NN”), often a deep neural network (“DNN”), using labelled training data so that the NN can determine the optimal beam when it is fed with M′ beam measurements, where M′<M. Among all the available beams, M′ number of beams, whose signal strength needs to be measured, are selected beforehand and fixed. The training data consists of tuples ((S₀, S₁, . . . , S_{M′-1}), B*), where Sᵢ denotes the signal strength (e.g., RSRP/SINR) over the i^{th} beam and B* is the best beam index for that particular network realization, corresponding to the beam measurements (S₀, S₁, . . . , S_{M′-1}). Thus, during the training, the NN is made to find a mapping between the beam measurements (S₀, S₁, . . . , S_{M′-1}) and the best beam index B*. When deployed, the NN is supplied with M′ beam measurements and the NN will determine the best beam index.

Such embodiments may work well for particular cell-sites and/or network configurations for which they are trained, and they enjoy fixed and, generally, low latency—once the NN is fed with M′ beam measurements, the NN computes the optimal beam quickly (in general, computations over NN are of low and/or moderate complexity and can be performed with low latency). However, they suffer, at least, from the following problems: 1) when the best beam that is to be found out corresponds to a corner case beam, then the ML method may commit an error in its beam selection—in other words, when the best beam is weakly related to the beam measurements that are input to the neural network, then there would be a higher probability that the NN will decide on the wrong beam as the best beam; 2) when the beam measurements are erroneous, resulting in corrupted and/or noisy input data to the NN, then the best beam inferred by the NN would have a high probability of error; and 3) in general, such methods are not adaptable and most likely exhibit poor performance when deployed over networks with different configurations than the ones for which they are trained for.

In certain embodiments, there may be machine learning for beam selection via sequential learning. Another class of ML solutions for beam selection are based on sequential learning (“SeqL”). Methods based on techniques such as active learning and bandit learning belong to the category of sequential learning (e.g., reinforcement learning is bandit learning with multiple states and hence may be considered as a more complex form of sequential learning).

A beam selection method based on SeqL learns about the beams sequentially, one after the other, to determine the optimal beam. At time step t, the algorithm measures the signal strength over the beam B_{I}_{ₜ}, where Iₜ ∈1, . . . , M is the index of the beam measured at time step t; Iₜ is determined based on the history [symbol] of beam measurements, given by [symbol] ={I₀, S_{I}_{₀}, I₁, S_{I}_{₁}, . . . , Iₜ₋₁, S_{I}_{ₜ₋₁}}, where Iⱼ is the beam index measured at time step j and S_{I}_{ⱼ} is the corresponding signal strength over beam Iⱼ. Thus, at every time step, a SeqL method decides which beam to measure in the next time step based on a careful evaluation of what beams have been measured so far, and what are the resulting signal strengths from those beams. To put it in other words, at every time step a SeqL method tries to balance between exploration and exploitation. Exploration of new (e.g., so far unmeasured) beams to gain useful information and exploiting the information that it has gained so far through past beam measurements. While dynamically selecting the beams to be measured, it tries to minimize the number of beam measurements, and directs itself to probe those beams that are highly likely to reveal new and useful information in deciding the optimal beam index. The SeqL method stops in one of the following ways and infers the optimal beam based on its learning (e.g., the beam measurements obtained so far): 1) in the fixed budget setting, the algorithm stops after T time steps, where T<<M, and outputs the inferred optimal beam; 2) when there is no fixed budget, the algorithm is made to stop once the latest beam measurement results in a signal strength equal to or above a certain threshold; and 3) in Bayesian sequential learning methods, it is possible to quantify the confidence about the inferred optimal beam and the algorithm can be made to stop after we reach the required confidence level in the beam that has been inferred as the optimal one.

In some embodiments, sequential methods enjoy the following advantages: 1) the beams to be measured are not fixed a priori as in the case of SupL methods—beams to be measured are selected dynamically based on the recent history of measurements making such methods highly efficient in traversing through the beams to be measured in such a way to minimize un-necessary measurements—this feature also reduces the difficulty in finding out the optimal beam when the optimal beam turns out to be not a typical beam but a belongs to a corner case; 2) performance of SeqL methods can be made robust to beam measurement errors—this can be achieved by suitably employing (e.g., with minor modifications, as needed) SeqL methods, such as active learning with noisy tests or contaminated and/or adversarial bandit learning; and 3) SeqL methods are easily adaptable and generalizable to different network configurations and different characteristics of the cell-sites—thus, they do not have the limitation of being useful only to a limited set of network configurations or cell-site characteristics and are applicable over a wide variety of network settings when deployed.

The probability with which a SeqL method determines the optimal beam is, in general, proportional to the number of time steps, or, equivalently, the number of beam measurements during its run-time. In situations that require highly accurate optimal beam selection, the latency of SeqL algorithms could become a serious problem. In other words, SeqL methods might require many time steps for determining the optimal beam with high confidence—the longer the algorithm runs, the higher the probability of correctly identifying the optimal beam.

Described herein are embodiments for beam selection that enjoys the advantages of both sequential and supervised learning methods while avoiding and/or alleviating some of the key disadvantages of sequential and supervised learning methods.

In various embodiments, consider the supervised learning methods described herein. As discussed, the beams to be measured (and fed into the NN as the input data for inference) are fixed a priori, independent of the realization of the network and/or physical propagation medium. Though this makes the beam selection method simple from both conceptual and implementation aspects (e.g., as we measure the same beams whenever we execute the beam selection method), such a rigidness makes the method to perform poorly when it needs to deal with noisy data and/or measurements and non-adaptable making it difficult to identify the optimal beam in situations where the optimal beam does not correspond to a typical beam and belongs to corner case.

In certain embodiments, the advantages of sequential learning methods (e.g., namely, adaptability, robustness to noisy measurements and/or data and ability to perform equally well in situations where the optimal beam corresponds to a corner case) are mainly due to their inherent nature of selecting the beams to be measured in a dynamic and/or adaptive manner. As the beam to be measured at each time step is decided based on the past beam measurements, such methods will have the innate ability to adopt and/or coarse correct the way they traverse through all the beams in searching for the optimal beam.

To keep having the advantage of fixed and low latency of SupL methods (e.g., relative to the variable latency, which may become high when we demand higher accuracy, in SeqL methods) and, at the same time to enjoy the merits of SeqL methods, such as adaptability to different network settings and/or physical propagation conditions and robustness to noisy measurements and/or data, the M′ beams are selected through a SeqL method thereby making the beam measurements in an adaptable and dynamic manner in SupL methods.

In some embodiments, beam selection can be explained as follows.

Consider the case of selecting one beam out of M beams through M′ measurements, where M′<M. A NN is trained through SupL method using labelled data so that, after training, the NN determines the optimal beam when it is fed with M′ beam measurements. The set of beams to be measured (with a cardinality of M′) is selected beforehand and it remains fixed.

The training data includes tuples ((I₀, S₀, I₁, S₁, . . . , I_{M′-1}, S_{M -}), B*), where Sj denotes the signal strength (e.g., RSRP/SINR) over the jt^{h} beam, Iⱼ denotes the index of the jt^{h} beam along with the physical co-ordinates of the beam and B* is the best beam index for that particular network realization, corresponding to the beam measurements (S₁, S₂, . . . , S_{M}). In contrast to a typical SupL method where the M′ number of beams, whose signal strength needs to be measured, are selected beforehand and fixed, the M′ beam measurements are selected through a SeqL method. That is, a SeqL method (e.g., such as an active learning algorithm or a bandit learning algorithm) starts functioning by making beam measurements in an adaptive manner, generating data {I₀, S_{I}_{₀}, I₁, S_{I}_{₁}, . . . , Iₜ₋₁, S_{I}_{ₜ₋₁}, . . . } and the required number of beam measurements are collected, to be precise M′ of them, to obtain (I₀, S₀, I₁, S₁, . . . , I_{M′-1}, S_{M′-1}). For the same instantiation, the ground truth is known, e.g., the optimal beam B* as the training data is generated either through simulations or through field trials (e.g., the proposed method is more suitable for generating the training data through simulations). The training tuple ((I₀, S₀, I₁, S₁, . . . , I_{M′-1}, S_{M′-1}), B*) can be constructed by joining the measurement tuple (I₀, S₀, I₁, S₁, . . . , I_{M′-1}, S_{M′-1}) and the optimal beam B* corresponding to those beam measurements. Note that, in the case of a typical SupL method the indices and/or physical co-ordinates of the measured beams are not included in the training data as the same beams are measured (or, equivalently, the indices and/or physical co-ordinates of the measured beams remain constant).

As is known for SupL methods, during the training, the NN is made to find a mapping between the beam measurements (I₀, S₀, I₁, S₁, . . . , I_{M′-1}, S_{M′1}) and the best beam index B*. When deployed, the NN is supplied with M′ beam measurements produced by the SeqL method, along with the indices and/or physical co-ordinates of the beams, and the NN will determine the optimal beam index based on the received inputs. In other words, after deploying the proposed beam selection method, whenever we need to perform the operation of beam selection, first the SeqL method starts measuring the beams in a dynamic and/or adaptive manner, producing the required number (i.e., M′ here) of beam measurements. In doing so, the sequential method, due to its inherent characteristics, tries to measure the beams that may reveal more useful information in determining the optimal beam. Thus, depending on the exact realization of the network and/or physical propagation conditions, the SeqL method dynamically choses the beams to be measured and generates a set of beam measurements that would be more useful and/or contain more information than that of a fixed set of beam measurements (as would have been done in case of a conventional SupL method). Based on the measurement data (I₀, S₀, I₁, S₁, . . . , I_{M′-1}, S_{M′-1}) obtained by the SeqL method, the NN would infer the optimal beam index B*.

Another variation of this method could be the following: after the SeqL method performs M′ beam measurements, it might have already determined the optimal beam with desired confidence level or with the received signal strength above a certain desired threshold. In such situations, the beam selection procedure can be terminated, and the beam determined by the SeqL method can be considered as the optimal beam, without making use of the NN for determining the optimal beam based on the beam measurements from the SeqL method. Such situations would save the time and computational complexity. Thus, the proposed method offers us flexibility and enable us to trade-off between the latency and/or complexity and the accuracy of beam prediction. Thus, the method effectively combines the sequential learning with supervised learning, both during training the NN and during inference and/or execution of the trained NN.

For explaining the detailed operations involved in the proposed beam selection method, let's consider the case where UE determines the optimal TX beam from the gNB in the downlink communication. It should be noted that such a method is applicable equally well for the case where the gNB determines the optimal TX beam from the UE in the uplink and in the case where the UE determines the best RX beam in the downlink. Notation: Iⱼ is the beam index measured at time step j, S_{I}_{ⱼ} is the corresponding signal strength over beam Iⱼ and B* denotes the optimal beam index.

For ease of illustration and without loss of generality, it is assumed that the training data is generated through simulations as follows: 1) initiate the sequential learning method to measure the beams—at time t=0, the SeqL method randomly chooses to measure a beam, say, beam I₀, producing S₀, the received signal strength over beam I₀; 2) at each time t, t=1, . . . , M′−1, the SeqL method decides Iₜ, the index of the beam to be measured at time t, based on the history of measurements given by [symbol] ={I₀, S_{I}_{₀}, I₁, S_{I}_{₁}, . . . , Iₜ₋₁, S_{I}_{ₜ₋₁}}; 3) at the end of M′ time steps, e.g., at t=M′, then there is the beam measurement tuple (I₀, S₀, I₁, S₁, . . . , I_{M′-1}, S_{M′-1}); 4) by attaching B*, the optimal beam for this instantiation of the network and/or channel realization (or, in other words, the optimal beam corresponding to the obtained beam measurements) to the beam measurement tuple obtained above, prepare ((I₀, S₀, I₁, S₁, . . . , I_{M′-1}, S_{M′-1}), B*), one sample of the labelled training data; 5) repeat steps 1 to 5 for generating multiple samples of the labelled training data; and 6) using the training data e.g., (typically consisting of large number of samples), train the neural network to predict the optimal beam when supplied with M′ beam measurements (e.g., if it is said—beam measurements, it means the tuple that includes the beam indices and the measured signal strengths over those beams).

In various embodiments, there may be an inference (or functioning after deployment). After deploying the trained beam selection method, whenever it is needed to carry out the beam selection procedure, the sequence of operations and/or events can be described as follows. Note that, the gNB keeps transmitting reference signals periodically over each of the M beams and the trained beam selection method (which involves both the SeqL method and the NN) is deployed and operated at the UE. Further, the network and/or gNB may inform the UE about the desired signal strength (e.g., RSRP and/or SINR) or the desired confidence level to be used for beam selection. Thus, whenever we mention that the SeqL method makes a beam measurement, the UE measures the received signal strength over the corresponding beam.

The inferences may be as follows: 1) UE initiates the beam selection procedure, and the very first step is to initiate sequential learning method to measure the beams; 2) at time t=0, the SeqL method randomly chooses to measure a beam, say, beam I₀, producing S₀, the received signal strength over beam I₀ (e.g., in other words, the UE makes its first beam measurement by measuring the received signal strength of the reference signal transmitted by gNB over beam I₀); 3) at each time t, t=1, . . . , M′−1, the SeqL method decides on Iₜ, the index of the beam to be measured at time t, based on the history of measurements given by [symbol] ={I₀, S_{I}_{₀}, I₁, S_{I}_{₁} , . . . , Iₜ₋₁, S_{I}_{ₜ₋₁}}(e.g., in other words, at each time t=1, . . . , M′−1, the UE measures the received signal strength over the beam Iₜ and stores the value S_{I}_{ₜ}); 4) at the end of M′ timesteps, e.g., at t=M′, the UE will have the beam measurement tuple (I₀, S₀, I₁, S₁, . . . , I_{M′-1}, S_{M′-1})—in a first implementation, the value of M′ remains fixed—in a second implementation, the value of M′ varies from time to time and decided by the UE depending on the beam measurement outputs from the SeqL method—in such a case, the UE may report an indication of M′ value to the network—in a first example, M′ value is fed back as a standalone report quantity; 5) at the end of M′ time steps, e.g., at t=M′, the UE examines the inferred output from the SeqL method a) if the beam suggested by the SeqL method is resulting in a signal strength that is equal to or above the desired signal strength, then stop the beam selection procedure, b) when the SeqL method can provide us with the confidence levels of its output (which is possible in case of Bayesian methods)—if the confidence level of the SeqL method is equal to or above the desired confidence level, then stop the beam selection procedure and consider the beam suggested by the SeqL method as the optimal beam—it should be noted that the desired signal strength or the desired confidence level can either be decided by the UE or can be configured by the network; 6) if the beam selection procedure is not terminated in Step 4, then the UE feeds the trained NN with the beam measurement tuple (I₀, S₀, I₁, S₁, . . . , I_{M′-1}, S_{M′-1}) produced by the SeqL method (refer to step 3); 7) the NN will infer the optimal beam using the received inputs (e.g., the beam measurement tuple (I₀, S₀, I₁, S₁, . . . , I_{M′-1}, S_{M′-1})); and 8) the UE terminates the beam selection procedure.

It should be noted that, for each beam measurement, the gNB must transmit a reference signal on the beam. As a priori it is not known what beams would be measured by the SeqL method, the gNB must configure reference signal transmission on all the M beams. In another implementation, the reference signal overhead may be reduced by making the gNB configure reference signals only on a subset of M″ beams where M′≤M″<M. This subset of M″ beams can be determined by observing what beams have been measured by the SeqL method over many runs of the beam selection procedure and by finding the beams that would be measured by the SeqL method with high probability.

In some embodiments, the terms antenna, panel, and antenna panel are used interchangeably. An antenna panel may be hardware that is used for transmitting and/or receiving radio signals at frequencies lower than 6 GHz (e.g., frequency range 1 (“FR1”)), or higher than 6 GHz (e.g., frequency range 2 (“FR2”) or millimeter wave (“mmWave”)). In certain embodiments, an antenna panel may include an array of antenna elements. Each antenna element may be connected to hardware, such as a phase shifter, that enables a control module to apply spatial parameters for transmission and/or reception of signals. The resulting radiation pattern may be called a beam, which may or may not be unimodal and may allow the device to amplify signals that are transmitted or received from one or more spatial directions.

In various embodiments, an antenna panel may or may not be virtualized as an antenna port. An antenna panel may be connected to a baseband processing module through a radio frequency (“RF”) chain for each transmission (e.g., egress) and reception (e.g., ingress) direction. A capability of a device in terms of a number of antenna panels, their duplexing capabilities, their beamforming capabilities, and so forth, may or may not be transparent to other devices. In some embodiments, capability information may be communicated via signaling or capability information may be provided to devices without a need for signaling. If information is available to other devices the information may be used for signaling or local decision making.

In some embodiments, a UE antenna panel may be a physical or logical antenna array including a set of antenna elements or antenna ports that share a common or a significant portion of a RF chain (e.g., in-phase and/or quadrature (“I/Q”) modulator, analog to digital (“A/D”) converter, local oscillator, phase shift network). The UE antenna panel or UE panel may be a logical entity with physical UE antennas mapped to the logical entity. The mapping of physical UE antennas to the logical entity may be up to UE implementation. Communicating (e.g., receiving or transmitting) on at least a subset of antenna elements or antenna ports active for radiating energy (e.g., active elements) of an antenna panel may require biasing or powering on of an RF chain which results in current drain or power consumption in a UE associated with the antenna panel (e.g., including power amplifier and/or low noise amplifier (“LNA”) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some embodiments, depending on implementation, a “panel” can have at least one of the following functionalities as an operational role of unit of antenna group to control its transmit (“TX”) beam independently, unit of antenna group to control its transmission power independently, unit of antenna group to control its transmission timing independently. The “panel” may be transparent to another node (e.g., next hop neighbor node). For certain condition(s), another node or network entity can assume the mapping between device's physical antennas to the logical entity “panel” may not be changed. For example, the condition may include until the next update or report from device or comprise a duration of time over which the network entity assumes there will be no change to the mapping. Device may report its capability with respect to the “panel” to the network entity. The device capability may include at least the number of “panels”. In one implementation, the device may support transmission from one beam within a panel; with multiple panels, more than one beam (one beam per panel) may be used for transmission. In another implementation, more than one beam per panel may be supported and/or used for transmission.

In some embodiments, an antenna port may be defined such that a channel over which a symbol on the antenna port is conveyed may be inferred from the channel over which another symbol on the same antenna port is conveyed.

In certain embodiments, two antenna ports are said to be quasi co-located (“QCL”) if large-scale properties of a channel over which a symbol on one antenna port is conveyed may be inferred from the channel over which a symbol on another antenna port is conveyed. Large-scale properties may include one or more of delay spread, Doppler spread, Doppler shift, average gain, average delay, and/or spatial receive (“RX”) parameters. Two antenna ports may be quasi co-located with respect to a subset of the large-scale properties and different subset of large-scale properties may be indicated by a QCL Type. For example, a qcl-Type may take one of the following values: 1) ‘QCL-TypeA’: {Doppler shift, Doppler spread, average delay, delay spread}; 2) ‘QCL-TypeB’: {Doppler shift, Doppler spread}; 3) ‘QCL-TypeC’: {Doppler shift, average delay}; and 4) ‘QCL-TypeD’: {Spatial Rx parameter}. Other QCL-Types may be defined based on combination of one or large-scale properties.

In various embodiments, spatial RX parameters may include one or more of: angle of arrival (“AoA”), dominant AoA, average AoA, angular spread, power angular spectrum (“PAS”) of AoA, average angle of departure (“AoD”), PAS of AoD, transmit and/or receive channel correlation, transmit and/or receive beamforming, and/or spatial channel correlation.

In certain embodiments, QCL-TypeA, QCL-TypeB, and QCL-TypeC may be applicable for all carrier frequencies, but QCL-TypeD may be applicable only in higher carrier frequencies (e.g., mmWave, FR2, and beyond), where the UE may not be able to perform omni-directional transmission (e.g., the UE would need to form beams for directional transmission). For a QCL-TypeD between two reference signals A and B, the reference signal A is considered to be spatially co-located with reference signal B and the UE may assume that the reference signals A and B can be received with the same spatial filter (e.g., with the same RX beamforming weights).

In some embodiments, an “antenna port” may be a logical port that may correspond to a beam (e.g., resulting from beamforming) or may correspond to a physical antenna on a device. In certain embodiments, a physical antenna may map directly to a single antenna port in which an antenna port corresponds to an actual physical antenna. In various embodiments, a set of physical antennas, a subset of physical antennas, an antenna set, an antenna array, or an antenna sub-array may be mapped to one or more antenna ports after applying complex weights and/or a cyclic delay to the signal on each physical antenna. The physical antenna set may have antennas from a single module or panel or from multiple modules or panels. The weights may be fixed as in an antenna virtualization scheme, such as cyclic delay diversity (“CDD”). A procedure used to derive antenna ports from physical antennas may be specific to a device implementation and transparent to other devices.

In certain embodiments, a transmission configuration indicator (“TCI”) state (“TCI-state”) associated with a target transmission may indicate parameters for configuring a quasi-co-location relationship between the target transmission (e.g., target RS of demodulation (“DM”) reference signal (“RS”) (“DM-RS”) ports of the target transmission during a transmission occasion) and a source reference signal (e.g., synchronization signal and physical broadcast channel block (“SSB”), CSI-RS, and/or SRS) with respect to quasi co-location type parameters indicated in a corresponding TCI state. The TCI describes which reference signals are used as a QCL source, and what QCL properties may be derived from each reference signal. A device may receive a configuration of a plurality of transmission configuration indicator states for a serving cell for transmissions on the serving cell. In some embodiments, a TCI state includes at least one source RS to provide a reference (e.g., UE assumption) for determining QCL and/or a spatial filter.

In some embodiments, spatial relation information associated with a target transmission may indicate a spatial setting between a target transmission and a reference RS (e.g., SSB, CSI-RS, and/or SRS). For example, a UE may transmit a target transmission with the same spatial domain filter used for receiving a reference RS (e.g., DL RS such as SSB and/or CSI-RS). In another example, a UE may transmit a target transmission with the same spatial domain transmission filter used for the transmission of a RS (e.g., UL RS such as SRS). A UE may receive a configuration of multiple spatial relation information configurations for a serving cell for transmissions on a serving cell.

In some of the implementations described, a UL TCI state is provided if a device is configured with separate DL/UL TCI by radio resource control (“RRC”) signaling. The UL TCI state may include a source reference signal which provides a reference for determining UL spatial domain transmission filter for the UL transmission (e.g., dynamic-grant and/or configured-grant based physical uplink shared channel (“PUSCH”), dedicated physical uplink control channel (“PUCCH”) resources) in a CC or across a set of configured CCs and/or bandwidth parts (“BWPs”).

In some of the implementations described, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides QCL Type-D indication (e.g., for device-dedicated physical downlink control channel (“PDCCH”) and/or physical downlink shared channel (“PDSCH”)) and is used to determine UL spatial transmission filter (e.g., for UE-dedicated PUSCH/PUCCH) for a CC or across a set of configured CCs/BWPs. In one example, the UL spatial transmission filter is derived from the RS of DL QCL Type D in the joint TCI state. The spatial setting of the UL transmission may be according to the spatial relation with a reference to the source RS configured with qcl-Type set to ‘typeD’ in the joint TCI state.

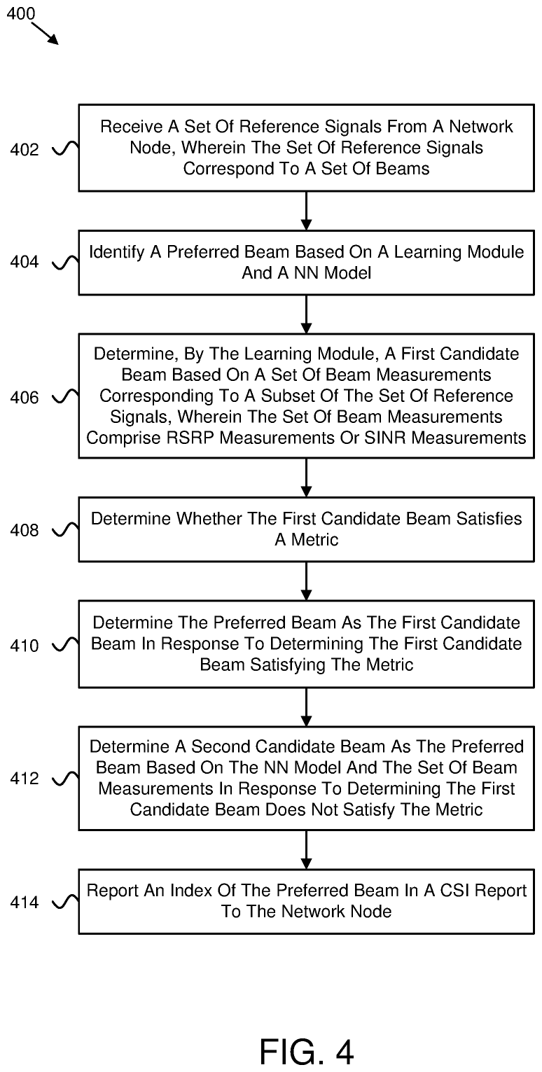

FIG. 4 is a flow chart diagram illustrating one embodiment of a method 400 for determining a beam for communication using learning techniques. In some embodiments, the method 400 is performed by an apparatus, such as the remote unit 102. In certain embodiments, the method 400 may be performed by a processor executing program code, for example, a microcontroller, a microprocessor, a CPU, a GPU, an auxiliary processing unit, a FPGA, or the like.

In various embodiments, the method 400 includes receiving 402, at a user equipment, a set of reference signals from a network node. The set of reference signals correspond to a set of beams. In some embodiments, the method 400 includes identifying 404 a preferred beam based on a learning module and a NN model. In certain embodiments, the method 400 includes determining 406, by the learning module, a first candidate beam based on a set of beam measurements corresponding to a subset of the set of reference signals. The set of beam measurements include RSRP measurements or SINR measurements. In various embodiments, the method 400 includes determining 408 whether the first candidate beam satisfies a metric. In some embodiments, the method 400 includes determining 410 the preferred beam as the first candidate beam in response to determining the first candidate beam satisfying the metric. In certain embodiments, the method 400 includes determining 412 a second candidate beam as the preferred beam based on the NN model and the set of beam measurements in response to determining the first candidate beam does not satisfy the metric. In various embodiments, the method 400 includes reporting 414 an index of the preferred beam in a CSI report to the network node.

In certain embodiments, the learning module is a sequential learning module. In some embodiments, the sequential learning module determines a second beam for measurement based on a measurement of a first beam from the set of beams. In various embodiments, the sequential learning module determines a next beam for measurement based on a set of prior beam measurements, where the set of beam measurements comprises the set of prior beam measurements and the next beam measurement.

In one embodiment, the method 400 further comprises training the NN model based on the set of beam measurements performed by the learning module using the set of reference signals. In certain embodiments, the method 400 further comprises receiving the NN model from the network node. In some embodiments, the metric comprises the preferred beam with a highest RSRP or SINR among the set of beams.

In various embodiments, the metric comprises the preferred beam with an RSRP or a SINR that exceeds a threshold value. In one embodiment, the metric comprises the preferred beam inferred with a confidence level that exceeds a threshold value. In certain embodiments, the threshold value is higher-layer configured by the network node.

In some embodiments, a number of beam measurements of the set of beam measurements is no larger than a number of beams in the set of beams. In various embodiments, the method 400 further comprises reporting a number of beam measurements of the set of beam measurements to the network node.

In one embodiment, the number of beam measurements is reported in the CSI report. In certain embodiments, the index of the preferred beam is reported via a parameter having a number of bits based on a base-two logarithm of a total number of beams.

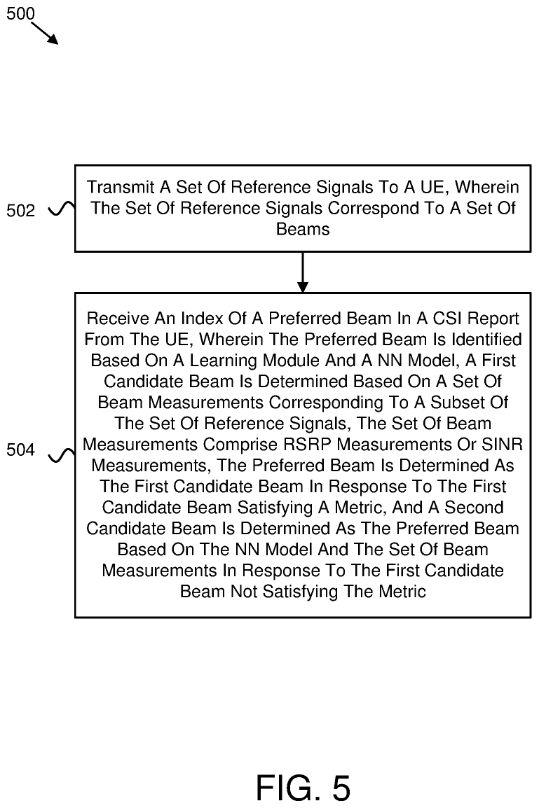

FIG. 5 is a flow chart diagram illustrating another embodiment of a method 500 for determining a beam for communication using learning techniques. In some embodiments, the method 500 is performed by an apparatus, such as the network unit 104. In certain embodiments, the method 500 may be performed by a processor executing program code, for example, a microcontroller, a microprocessor, a CPU, a GPU, an auxiliary processing unit, a FPGA, or the like.

In various embodiments, the method 500 includes transmitting 502, at a network node, a set of reference signals to a UE, wherein the set of reference signals correspond to a set of beams. In some embodiments, the method 500 includes receiving 504 an index of a preferred beam in a CSI report from the UE. The preferred beam is identified based on a learning module and a NN model, a first candidate beam is determined based on a set of beam measurements corresponding to a subset of the set of reference signals, the set of beam measurements comprise RSRP measurements or SINR measurements, the preferred beam is determined as the first candidate beam in response to the first candidate beam satisfying a metric, and a second candidate beam is determined as the preferred beam based on the NN model and the set of beam measurements in response to the first candidate beam not satisfying the metric.

In certain embodiments, the learning module is a sequential learning module. In some embodiments, the method 500 further comprises transmitting the NN model to the UE. In various embodiments, the metric comprises the preferred beam with a highest RSRP or SINR among the set of beams.

In one embodiment, the metric comprises the preferred beam with an RSRP or a SINR that exceeds a threshold value. In certain embodiments, the metric comprises the preferred beam inferred with a confidence level that exceeds a threshold value. In some embodiments, the method 500 further comprises transmitting the threshold value via a higher-layer configuration to the UE.

In various embodiments, a number of beam measurements of the set of beam measurements is no larger than a number of beams in the set of beams. In one embodiment, the method 500 further comprises receiving information indicating a number of beam measurements of the set of beam measurements from the UE.

In certain embodiments, the number of beam measurements is received in the CSI report. In some embodiments, the index of the preferred beam is received via a parameter having a number of bits based on a base-two logarithm of a total number of beams.

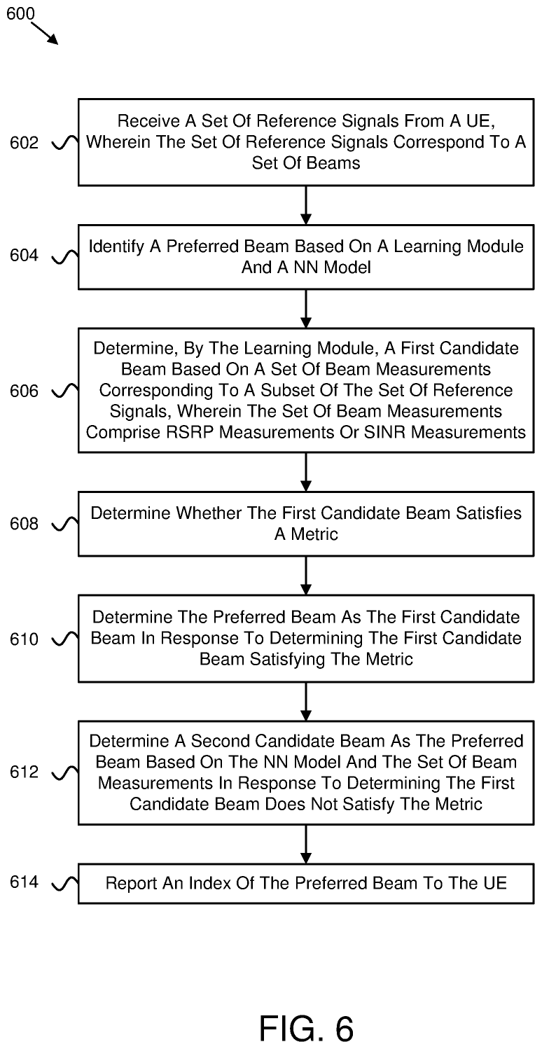

FIG. 6 is a flow chart diagram illustrating a further embodiment of a method 600 for determining a beam for communication using learning techniques. In some embodiments, the method 600 is performed by an apparatus, such as the network unit 104. In certain embodiments, the method 600 may be performed by a processor executing program code, for example, a microcontroller, a microprocessor, a CPU, a GPU, an auxiliary processing unit, a FPGA, or the like.

In various embodiments, the method 600 includes receiving 602, at a network node, a set of reference signals from a UE. The set of reference signals correspond to a set of beams. In some embodiments, the method 600 includes identifying 604 a preferred beam based on a learning module and a NN model. In certain embodiments, the method 600 includes determining 606, by the learning module, a first candidate beam based on a set of beam measurements corresponding to a subset of the set of reference signals. The set of beam measurements include RSRP measurements or SINR measurements. In various embodiments, the method 600 includes determining 608 whether the first candidate beam satisfies a metric. In some embodiments, the method 600 includes determining 610 the preferred beam as the first candidate beam in response to determining the first candidate beam satisfying the metric. In certain embodiments, the method 600 includes determining 612 a second candidate beam as the preferred beam based on the NN model and the set of beam measurements in response to determining the first candidate beam does not satisfy the metric. In various embodiments, the method 600 includes reporting 614 an index of the preferred beam to the UE.

In certain embodiments, the learning module is a sequential learning module. In some embodiments, the method 600 further comprises training the NN model based on the set of beam measurements performed by the learning module using the set of reference signals received from the UE. In various embodiments, the method 600 further comprises receiving the NN model from either the UE or another network node.

In one embodiment, the metric comprises the preferred beam with a highest RSRP or SINR among the set of beams. In certain embodiments, the metric comprises the preferred beam with an RSRP or a SINR that exceeds a threshold value. In some embodiments, the metric comprises the preferred beam inferred with a confidence level that exceeds a threshold value.

In various embodiments, a number of beam measurements of the set of beam measurements is no larger than a number of beams in the set of beams. In one embodiment, the index of the preferred beam is transmitted to the UE via a parameter having a number of bits based on a base-two logarithm of a total number of beams.

In one embodiment, an apparatus for wireless communication, the apparatus comprises: a processor; and a memory coupled to the processor, the processor configured to cause the apparatus to: receive a set of reference signals from a network node, wherein the set of reference signals correspond to a set of beams; identify a preferred beam based on a learning module and a NN model; determine, by the learning module, a first candidate beam based on a set of beam measurements corresponding to a subset of the set of reference signals, wherein the set of beam measurements comprise RSRP measurements or SINR measurements; determine whether the first candidate beam satisfies a metric; determine the preferred beam as the first candidate beam in response to determining the first candidate beam satisfying the metric; determine a second candidate beam as the preferred beam based on the NN model and the set of beam measurements in response to determining the first candidate beam does not satisfy the metric; and report an index of the preferred beam in a CSI report to the network node.

In certain embodiments, the learning module is a sequential learning module.

In some embodiments, the sequential learning module determines a second beam for measurement based on a measurement of a first beam from the set of beams.

In various embodiments, the sequential learning module determines a next beam for measurement based on a set of prior beam measurements, where the set of beam measurements comprises the set of prior beam measurements and the next beam measurement.

In one embodiment, the processor is further configured to cause the apparatus to train the NN model based on the set of beam measurements performed by the learning module using the set of reference signals.

In certain embodiments, the processor is further configured to cause the apparatus to receive the NN model from the network node.

In some embodiments, the metric comprises the preferred beam with a highest RSRP or SINR among the set of beams.

In various embodiments, the metric comprises the preferred beam with an RSRP or a SINR that exceeds a threshold value.

In one embodiment, the metric comprises the preferred beam inferred with a confidence level that exceeds a threshold value.

In certain embodiments, the threshold value is higher-layer configured by the network node.

In some embodiments, a number of beam measurements of the set of beam measurements is no larger than a number of beams in the set of beams.

In various embodiments, the processor is further configured to cause the apparatus to report a number of beam measurements of the set of beam measurements to the network node.

In one embodiment, the number of beam measurements is reported in the CSI report.

In certain embodiments, the index of the preferred beam is reported via a parameter having a number of bits based on a base-two logarithm of a total number of beams.

In one embodiment, a method at a UE, the method comprises:receiving a set of reference signals from a network node, wherein the set of reference signals correspond to a set of beams; identifying a preferred beam based on a learning module and a NN model; determining, by the learning module, a first candidate beam based on a set of beam measurements corresponding to a subset of the set of reference signals, wherein the set of beam measurements comprise RSRP measurements or SINR measurements; determining whether the first candidate beam satisfies a metric; determining the preferred beam as the first candidate beam in response to determining the first candidate beam satisfying the metric; determining a second candidate beam as the preferred beam based on the NN model and the set of beam measurements in response to determining the first candidate beam does not satisfy the metric; and reporting an index of the preferred beam in a CSI report to the network node.

In certain embodiments, the learning module is a sequential learning module.

In some embodiments, the sequential learning module determines a second beam for measurement based on a measurement of a first beam from the set of beams.

In various embodiments, the sequential learning module determines a next beam for measurement based on a set of prior beam measurements, where the set of beam measurements comprises the set of prior beam measurements and the next beam measurement.

In one embodiment, the method further comprises training the NN model based on the set of beam measurements performed by the learning module using the set of reference signals.

In certain embodiments, the method further comprises receiving the NN model from the network node.

In some embodiments, the metric comprises the preferred beam with a highest RSRP or SINR among the set of beams.

In various embodiments, the metric comprises the preferred beam with an RSRP or a SINR that exceeds a threshold value.

In one embodiment, the metric comprises the preferred beam inferred with a confidence level that exceeds a threshold value.

In certain embodiments, the threshold value is higher-layer configured by the network node.

In some embodiments, a number of beam measurements of the set of beam measurements is no larger than a number of beams in the set of beams.

In various embodiments, the method further comprises reporting a number of beam measurements of the set of beam measurements to the network node.

In one embodiment, the number of beam measurements is reported in the CSI report.

In certain embodiments, the index of the preferred beam is reported via a parameter having a number of bits based on a base-two logarithm of a total number of beams.

In one embodiment, an apparatus for wireless communication, the apparatus comprises: a processor; and a memory coupled to the processor, the processor configured to cause the apparatus to: transmit a set of reference signals to a UE, wherein the set of reference signals correspond to a set of beams; and receive an index of a preferred beam in a CSI report from the UE, wherein the preferred beam is identified based on a learning module and a NN model, a first candidate beam is determined based on a set of beam measurements corresponding to a subset of the set of reference signals, the set of beam measurements comprise RSRP measurements or SINR measurements, the preferred beam is determined as the first candidate beam in response to the first candidate beam satisfying a metric, and a second candidate beam is determined as the preferred beam based on the NN model and the set of beam measurements in response to the first candidate beam not satisfying the metric.

In certain embodiments, the learning module is a sequential learning module.

In some embodiments, the processor is further configured to cause the apparatus to transmit the NN model to the UE.

In various embodiments, the metric comprises the preferred beam with a highest RSRP or SINR among the set of beams.

In one embodiment, the metric comprises the preferred beam with an RSRP or a SINR that exceeds a threshold value.

In certain embodiments, the metric comprises the preferred beam inferred with a confidence level that exceeds a threshold value.

In some embodiments, the processor is further configured to cause the apparatus to transmit the threshold value via a higher-layer configuration to the UE.

In various embodiments, a number of beam measurements of the set of beam measurements is no larger than a number of beams in the set of beams.

In one embodiment, the processor is further configured to cause the apparatus to receive information indicating a number of beam measurements of the set of beam measurements from the UE.

In certain embodiments, the number of beam measurements is received in the CSI report.

In some embodiments, the index of the preferred beam is received via a parameter having a number of bits based on a base-two logarithm of a total number of beams.

In one embodiment, a method at a network node, the method comprises: transmitting a set of reference signals to a UE, wherein the set of reference signals correspond to a set of beams; and receiving an index of a preferred beam in a CSI report from the UE, wherein the preferred beam is identified based on a learning module and a NN model, a first candidate beam is determined based on a set of beam measurements corresponding to a subset of the set of reference signals, the set of beam measurements comprise RSRP measurements or SINR measurements, the preferred beam is determined as the first candidate beam in response to the first candidate beam satisfying a metric, and a second candidate beam is determined as the preferred beam based on the NN model and the set of beam measurements in response to the first candidate beam not satisfying the metric.

In certain embodiments, the learning module is a sequential learning module.

In some embodiments, the method further comprises transmitting the NN model to the UE.

In various embodiments, the metric comprises the preferred beam with a highest RSRP or SINR among the set of beams.

In one embodiment, the metric comprises the preferred beam with an RSRP or a SINR that exceeds a threshold value.

In certain embodiments, the metric comprises the preferred beam inferred with a confidence level that exceeds a threshold value.

In some embodiments, the method further comprises transmitting the threshold value via a higher-layer configuration to the UE.

In various embodiments, a number of beam measurements of the set of beam measurements is no larger than a number of beams in the set of beams.

In one embodiment, the method further comprises receiving information indicating a number of beam measurements of the set of beam measurements from the UE.

In certain embodiments, the number of beam measurements is received in the CSI report.

In some embodiments, the index of the preferred beam is received via a parameter having a number of bits based on a base-two logarithm of a total number of beams.

In one embodiment, an apparatus for wireless communication, the apparatus comprises: a processor; and a memory coupled to the processor, the processor configured to cause the apparatus to: receive a set of reference signals from a UE, wherein the set of reference signals correspond to a set of beams; identify a preferred beam based on a learning module and a NN model; determine, by the learning module, a first candidate beam based on a set of beam measurements corresponding to a subset of the set of reference signals, wherein the set of beam measurements comprise RSRP measurements or SINR measurements; determine whether the first candidate beam satisfies a metric; determine the preferred beam as the first candidate beam in response to determining the first candidate beam satisfying the metric; determine a second candidate beam as the preferred beam based on the NN model and the set of beam measurements in response to determining the first candidate beam does not satisfy the metric; and report an index of the preferred beam to the UE.

In certain embodiments, the learning module is a sequential learning module.

In some embodiments, the processor is further configured to cause the apparatus to train the NN model based on the set of beam measurements performed by the learning module using the set of reference signals received from the UE.

In various embodiments, the processor is further configured to cause the apparatus to receive the NN model from either the UE or another network node.

In one embodiment, the metric comprises the preferred beam with a highest RSRP or SINR among the set of beams.

In certain embodiments, the metric comprises the preferred beam with an RSRP or a SINR that exceeds a threshold value.

In some embodiments, the metric comprises the preferred beam inferred with a confidence level that exceeds a threshold value.

In various embodiments, a number of beam measurements of the set of beam measurements is no larger than a number of beams in the set of beams.

In one embodiment, the index of the preferred beam is transmitted to the UE via a parameter having a number of bits based on a base-two logarithm of a total number of beams.

In one embodiment, a method at a network node, the method comprises: receiving a set of reference signals from a UE, wherein the set of reference signals correspond to a set of beams; identifying a preferred beam based on a learning module and a NN model; determining, by the learning module, a first candidate beam based on a set of beam measurements corresponding to a subset of the set of reference signals, wherein the set of beam measurements comprise RSRP measurements or SINR measurements; determining whether the first candidate beam satisfies a metric; determining the preferred beam as the first candidate beam in response to determining the first candidate beam satisfying the metric; determining a second candidate beam as the preferred beam based on the NN model and the set of beam measurements in response to determining the first candidate beam does not satisfy the metric; and reporting an index of the preferred beam to the UE.

In certain embodiments, the learning module is a sequential learning module.

In some embodiments, the method further comprises training the NN model based on the set of beam measurements performed by the learning module using the set of reference signals received from the UE.

In various embodiments, the method further comprises receiving the NN model from either the UE or another network node.

In one embodiment, the metric comprises the preferred beam with a highest RSRP or SINR among the set of beams.

In certain embodiments, the metric comprises the preferred beam with an RSRP or a SINR that exceeds a threshold value.

In some embodiments, the metric comprises the preferred beam inferred with a confidence level that exceeds a threshold value.

In various embodiments, a number of beam measurements of the set of beam measurements is no larger than a number of beams in the set of beams.

In one embodiment, the index of the preferred beam is transmitted to the UE via a parameter having a number of bits based on a base-two logarithm of a total number of beams.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
receive a set of reference signals from a network node, wherein the set of reference signals correspond to a set of beams;
identify a preferred beam based on a learning module and a neural network (NN) model;
determine, by the learning module, a first candidate beam based on a set of beam measurements corresponding to a subset of the set of reference signals, wherein the set of beam measurements comprise reference signal received power (RSRP) measurements or signal-to-interference and noise ratio (SINR) measurements;
determine whether the first candidate beam satisfies a metric;
determine the preferred beam as the first candidate beam in response to determining the first candidate beam satisfying the metric;
determine a second candidate beam as the preferred beam based on the NN model and the set of beam measurements in response to determining the first candidate beam does not satisfy the metric; and
report an index of the preferred beam in a channel state information (CSI) report to the network node.

2. The UE of claim 1, wherein the learning module is a sequential learning module.

3. The UE of claim 2, wherein the sequential learning module determines a second beam for measurement based on a measurement of a first beam from the set of beams.

4. The UE of claim 2, wherein the sequential learning module determines a next beam for measurement based on a set of prior beam measurements, and wherein the set of beam measurements comprises the set of prior beam measurements and the next beam measurement.

5. The UE of claim 1, wherein the at least one processor is configured to cause the UE to train the NN model based on the set of beam measurements performed by the learning module using the set of reference signals.

6. The UE of claim 1, wherein the at least one processor is configured to cause the UE to receive the NN model from the network node.

7. The UE of claim 1, wherein the metric comprises the preferred beam with a highest RSRP or SINR among the set of beams.

8. The UE of claim 1, wherein the metric comprises the preferred beam with an RSRP or a SINR that exceeds a threshold value.

9. The UE of claim 1, wherein the metric comprises the preferred beam inferred with a confidence level that exceeds a threshold value.

10. The UE of claim 9, wherein the threshold value is higher-layer configured by the network node.

11. The UE of claim 1, wherein a number of beam measurements of the set of beam measurements is no larger than a number of beams in the set of beams.

12. The UE of claim 1, wherein the at least one processor is configured to cause the UE to report a number of beam measurements of the set of beam measurements to the network node.

13. The UE of claim 12, wherein the number of beam measurements is reported in the CSI report.

14. The UE of claim 1, wherein the index of the preferred beam is reported via a parameter having a number of bits based on a base-two logarithm of a total number of beams.

15. A processor for wireless communication, comprising:
at least one controller coupled with at least one memory and configured to cause the processor to:
receive a set of reference signals from a network node, wherein the set of reference signals correspond to a set of beams;
identify a preferred beam based on a learning module and a neural network (NN) model;
determine, by the learning module, a first candidate beam based on a set of beam measurements corresponding to a subset of the set of reference signals, wherein the set of beam measurements comprise reference signal received power (RSRP) measurements or signal-to-interference and noise ratio (SINR) measurements;
determine whether the first candidate beam satisfies a metric;
determine the preferred beam as the first candidate beam in response to determining the first candidate beam satisfying the metric;
determine a second candidate beam as the preferred beam based on the NN model and the set of beam measurements in response to determining the first candidate beam does not satisfy the metric; and
report an index of the preferred beam in a channel state information (CSI) report to the network node.

16. A base station, comprising:
at least one memory; and
at least one processor coupled with the at least one memory and configured to cause the base station to:
transmit a set of reference signals to a user equipment (UE), wherein the set of reference signals correspond to a set of beams; and
receive an index of a preferred beam in a channel state information (CSI) report from the UE, wherein the preferred beam is identified based on a learning module and a neural network (NN) model, a first candidate beam is determined based on a set of beam measurements corresponding to a subset of the set of reference signals, the set of beam measurements comprise reference signal received power (RSRP) measurements or signal-to-interference and noise ratio (SINR) measurements, the preferred beam is determined as the first candidate beam in response to the first candidate beam satisfying a metric, and a second candidate beam is determined as the preferred beam based on the NN model and the set of beam measurements in response to the first candidate beam not satisfying the metric.

17. A base station, comprising:
at least one memory; and
at least one processor coupled with the at least one memory and configured to cause the base station to:
receive a set of reference signals from a user equipment (UE), wherein the set of reference signals correspond to a set of beams;
identify a preferred beam based on a learning module and a neural network (NN) model;
determine, by the learning module, a first candidate beam based on a set of beam measurements corresponding to a subset of the set of reference signals, wherein the set of beam measurements comprise reference signal received power (RSRP) measurements or signal-to-interference and noise ratio (SINR) measurements;
determine whether the first candidate beam satisfies a metric;
determine the preferred beam as the first candidate beam in response to determining the first candidate beam satisfying the metric;
determine a second candidate beam as the preferred beam based on the NN model and the set of beam measurements in response to determining the first candidate beam does not satisfy the metric; and
report an index of the preferred beam to the UE.

18. The base station of claim 17, wherein the learning module is a sequential learning module.

19. The base station of claim 17, wherein the at least one processor is configured to cause the base station to train the NN model based on the set of beam measurements performed by the learning module using the set of reference signals received from the UE.

20. The base station of claim 17, wherein the at least one processor is configured to cause the base station to receive the NN model from either the UE or another network node.
